(19) United States
(12) Patent Application Publication
(10) Pub. No.: US 2026/0065236 A1
(43) Pub. Date: Mar. 5, 2026

(54) GENERATION AND ASSIGNMENT OF EXPIRATION STATUS CHECKING TASKS USING A MACHINE LEARNING MODEL TO PREDICT ITEM FRESHNESS

(71) Applicant: Maplebear Inc., San Francisco, CA (US)

(72) Inventors: Erica Jazayeri Quintana, San Francisco (CA); Brent Scheibelhut, Toronto (CA)

(21) Appl. No.: 18/816,407

(22) Filed: Aug. 27, 2024

(51) Int. Cl. G06Q 10/30; G06N 3/084

(52) U.S. Cl. CPC G06Q 10/30; G06N 3/084

(57) ABSTRACT

Generation and assignment of expiration status checking tasks using an item freshness model is described. Candidate perishable items are identified to check for expiration at a source location associated with a source computing system. The candidate perishable items are applied to an item freshness model to generate scores for the plurality of candidate perishable items. Based in part on the scores, one or more of the candidate perishable items are selected as one or more perishable items for a picker to check for expiration status. Instructions are provided to a picker client device associated with the picker to check the one or more perishable items for expiration status. Expiration status data is received from the picker client device describing whether each of the one or more perishable items are expired. The expiration status data is provided to the source computing system.

### BACKGROUND

Retailers spend significant time and money to ensure that products they are selling are not expired. But often there is no record of expiration dates in inventory files, as such there is not an efficient mechanism to notify retailers that products are expired and should be removed from their shelves. As such, despite retailers'best efforts, there may be products on their shelves that are past their expiration dates. For example, retailers could deploy personnel to check expiration dates manually, but given the large number of products to check at a particular location, this would be infeasible. Accordingly, there is a need for a technical solution for prioritizing items to check and managing the assignment of those tasks in a dynamic environment where variables that affect the priority of the tasks are constantly changing.

### SUMMARY

In accordance with one or more aspects of the disclosure, generation and assignment of expiration status checking tasks using an item freshness model are described. Candidate perishable items are identified by an online system to check for expiration at a source location associated with a source computing system. For example, the online system may use one or more source expiration status requests to check expiration statuses of a plurality of perishable items at one or more source locations to identify candidate perishable items. The online system may apply the candidate perishable items to an item freshness model. The item freshness model is a machine learned model that is configured to score the plurality of candidate perishable items. Based in part on the scores of the plurality of candidate perishable items, the online system may select one or more of the candidate perishable items as one or more perishable items for a picker to check for expiration status. The online system provides instructions to a picker client device associated with the picker to check the one or more perishable items for expiration status. The online system receives expiration status data from the picker client device describing whether each of the one or more perishable items are expired. The online system provides the expiration status data to the source computing system.

In some aspects, the techniques described herein relate to a method, performed at a computer system including a processor and a non-transitory computer readable medium, including: identifying a plurality of candidate perishable items to check for expiration status at a source location associated with a source computing system; applying the plurality of candidate perishable items to an item freshness model to generate scores for the plurality of candidate perishable items, wherein the item freshness model was trained by: accessing a set of training examples including training expiration status data for a training set of perishable items, training source expiration status requests for the training set of perishable items, and training customer complaint data for the training set of perishable items, applying the item freshness model to the set of training examples to generate a training output corresponding to a predicted set of scores for the training set of perishable items, back-propagating one or more error terms obtained from one or more loss functions to update a set of parameters of the item freshness model, and one or more of the error terms are based on a difference between a label applied to a test interaction of the set of training examples and the predicted set of scores, and stopping the back-propagation after the one or more loss functions satisfy one or more criteria; selecting, based in part on the scores, one or more of the plurality of candidate perishable items as one or more perishable items for a picker to check for expiration status; providing instructions to a picker client device associated with the picker to check the one or more perishable items for expiration status; receiving expiration status data from the picker client device describing whether each of the one or more perishable items are expired; and providing the expiration status data to the source computing system.

In some aspects, the techniques described herein relate to a computer program product including a non-transitory computer readable storage medium having instructions encoded thereon that, when executed by a processor of a computer system, cause the computer system to: identify a plurality of candidate perishable items to check for expiration status at a source location associated with a source computing system; apply the plurality of candidate perishable items to an item freshness model to generate scores for the plurality of candidate perishable items, wherein the item freshness model was trained by: accessing a set of training examples including training expiration status data for a training set of perishable items, training source expiration status requests for the training set of perishable items, and training customer complaint data for the training set of perishable items, applying the item freshness model to the set of training examples to generate a training output corresponding to a predicted set of scores for the training set of perishable items, back-propagating one or more error terms obtained from one or more loss functions to update a set of parameters of the item freshness model, and one or more of the error terms are based on a difference between a label applied to a test interaction of the set of training examples and the predicted set of scores, and stopping the back-propagation after the one or more loss functions satisfy one or more criteria; select, based in part on the scores, one or more of the plurality of candidate perishable items as one or more perishable items for a picker to check for expiration status; provide instructions to a picker client device associated with the picker to check the one or more perishable items for expiration status; receive expiration status data from the picker client device describing whether each of the one or more perishable items are expired; and provide the expiration status data to the source computing system.

In some aspects, the techniques described herein relate to a computer system including: a processor; and a non-transitory computer readable storage medium having instructions encoded thereon that, when executed by the processor, cause the computer system to: identify a plurality of candidate perishable items to check for expiration status at a source location associated with a source computing system, apply the plurality of candidate perishable items to an item freshness model to generate scores for the plurality of candidate perishable items, wherein the item freshness model was trained by: accessing a set of training examples including training expiration status data for a training set of perishable items, training source expiration status requests for the training set of perishable items, and training customer complaint data for the training set of perishable items, applying the item freshness model to the set of training examples to generate a training output corresponding to a predicted set of scores for the training set of perishable items, back-propagating one or more error terms obtained from one or more loss functions to update a set of parameters of the item freshness model, and one or more of the error terms are based on a difference between a label applied to a test interaction of the set of training examples and the predicted set of scores, and stopping the back-propagation after the one or more loss functions satisfy one or more criteria; select, based in part on the scores, one or more of the plurality of candidate perishable items as one or more perishable items for a picker to check for expiration status, provide instructions to a picker client device associated with the picker to check the one or more perishable items for expiration status, receive expiration status data from the picker client device describing whether each of the one or more perishable items are expired, and provide the expiration status data to the source computing system.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3A is an example sequence diagram describing generation and assignment of expiration status checking tasks in conjunction with an order, in accordance with some embodiments.

FIG. 3B is an example sequence diagram describing using expiration status data to respond to a complaint stemming from the order of FIG. 3A.

FIG. 4A illustrates an example collection interface that is presenting a list of items, in accordance with some embodiments.

FIG. 4B illustrates the collection interface of FIG. 4A presenting an item page responsive to selection of a perishable item that is part of the order.

FIG. 4C illustrates the collection interface of FIG. 4A presenting an item page responsive to selection of a perishable item that is not part of the order.

FIG. 5 is a flowchart for a method of generation and assignment of expiration status checking tasks using an item freshness model, in accordance with some embodiments.

### DETAILED DESCRIPTION

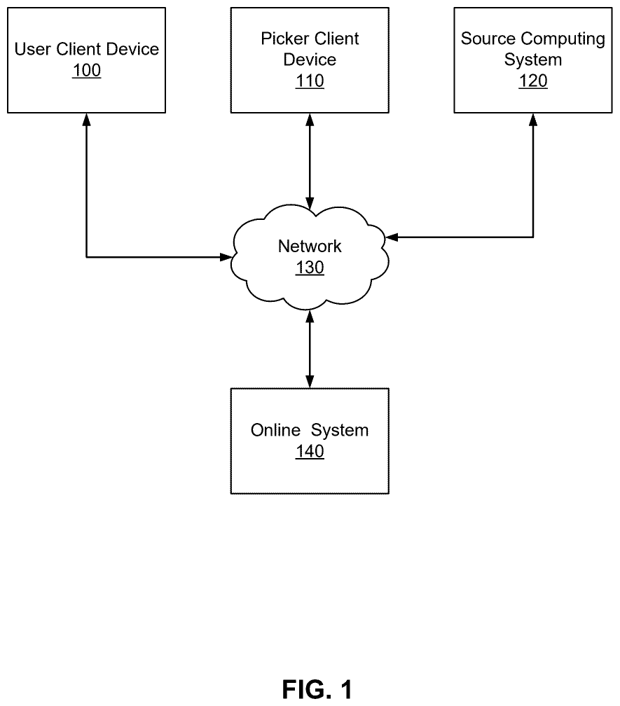

FIG. 1 illustrates an example system environment for an online system 140, in accordance with one or more embodiments. In some embodiments, the online system 140 may be an online concierge system. The system environment illustrated in FIG. 1 includes a user client device 100, a picker client device 110, a source computing system 120, a network 130, and the online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and sources may be generically referred to as “users” of the online system 140. Additionally, while one user client device 100, picker client device 110, and source computing system 120 are illustrated in FIG. 1, any number of customers, pickers, and sources may interact with the online system 140. As such, there may be more than one user client device 100, picker client device 110, or source computing system 120.

In some embodiments, the user client device 100 is a client device through which a customer may interact with the picker client device 110, the source computing system 120, or the online system 140. The user client device 100 can be a personal or mobile computing device, such as a smartphone, a tablet, a laptop computer, or desktop computer. In some embodiments, the user client device 100 may be a smart cart. A smart cart is a physical cart that includes sensors (e.g., camera, scanner, scale, etc.) to detect items placed in the smart cart, a display, and a controller. For example, the controller may use data from the sensors to identify items placed in the cart, and present which items are in the smart cart (and, e.g., a current total price of the items) using the display. The controller also may add and/or remove items to a shopping cart (online) of the online system 140 to ensure that the content of the shopping cart is the same as the content of the smart cart. As items are added to the shopping cart, a shopping list for the order may be updated accordingly. The controller may also use the display to present recommendations for items in accordance with instructions from the online system 140. In some embodiments, once a customer is done shopping, the customer may pay via the smart cart without having to go through the conventional check-out line. In some embodiments, the user client device 100 executes a client application that uses an application programming interface (API) to communicate with the online system 140.

A customer uses the user client device 100 to place an order with the online system 140. An order specifies a set of items to be delivered to the customer. An “item,” as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the customer. The ordering interface is a user interface that the customer can use to place an order with the online system 140. The ordering interface may be part of a client application operating on the user client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

Items with expiration dates are referred to as “perishable items.” An expiration status may refer to whether a date (e.g., expiration date) when an item is to be utilized by has passed. An expiration date may be, an “expires on” date, a “do not use” date, a “best by” date, a “use by” date, a “sell by” date, some other date before which an item should be utilized, or some combination thereof.

In some embodiments, the user client device 100 may be used by the customer to provide a complaint about an order. For example, a customer may use the user client device 100 (e.g., via the ordering interface) to provide a complaint to the online system 140 regarding a perishable item received in an order that may have been past its expiration date.

The user client device 100 may receive additional content from the online system 140 to present to a customer. For example, the user client device 100 may receive responses to complaints from the online system 140. In some embodiments, if the online system 140 determines that the complaint is correct, a response to the complaint about an item may include, e.g., an appeasement (e.g., refund, coupon, etc.) for having received in their order an item that is past its expiration date. In embodiments where the online system 140 has determined that the complaint is in error, a response to the complaint may include, e.g., an image of an expiration date of the item, an image of the item, an explanation why no appeasement is to be provided (e.g., if the item delivered by the picker was not expired), or some combination thereof. In some embodiments, the user client device 100 may present the received additional content to the customer via the ordering interface.

Additionally, the user client device 100 includes a communication interface that allows the customer to communicate with a picker that is servicing the customer's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the customer. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the customer and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or desktop computer. In some embodiments, the picker client device 110 is a smart cart. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the customer's order to the picker in a collection interface. The collection interface is a user interface that provides information to the picker on which items to collect for a customer's order and the quantities of the items. The collection interface also may present one or more perishable items for the picker to confirm expiration status. In some embodiments, the collection interface provides multiple orders from multiple customers for the picker to service at the same time from the same source location. The collection interface further presents instructions that the customer may have included related to the collection of items in the order. Additionally, the collection interface may present a location of each item in the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker client device 110 may receive instructions (e.g., via the collection interface) to instruct the picker to check one or more perishable items for expiration status at a source location. In some embodiments, the instructions may be to check expiration status of one or more perishable items that are not part of an order for a customer.

In some embodiments, the received instructions are included as part of the order received from the online system 140. For example, the order may include items for pickers to collect requested items for a customer as well as check expiration statuses of items that are not part of the order for the customer. And in some embodiments, the order may include perishable items for which the picker is instructed to check their expiration status. The collection interface may present a location of each perishable item whose expiration status is to be checked in the source location, and may even specify a sequence in which the picker should check the expiration statuses of the perishable items, along with collecting the items in the order for improved efficiency in collecting items.

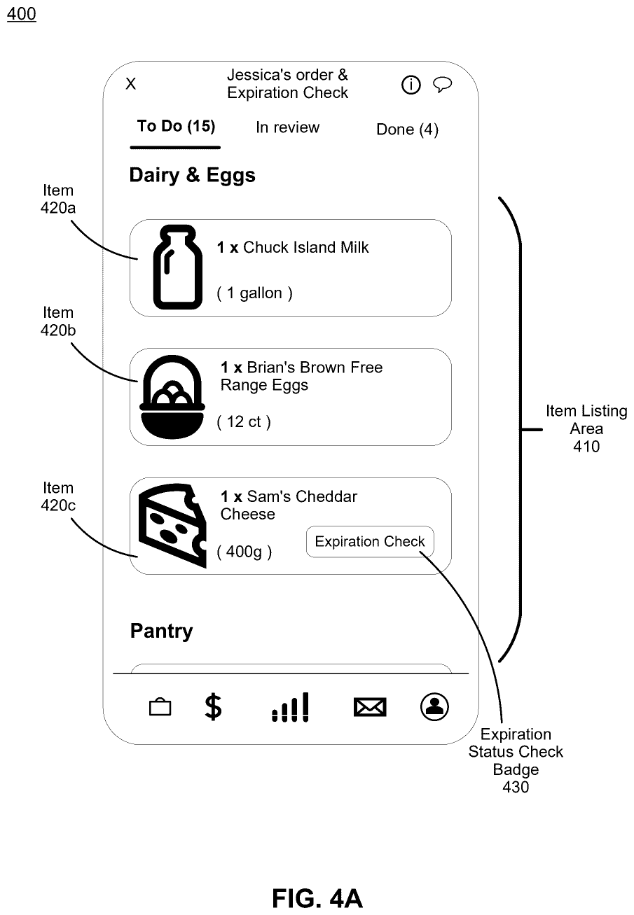

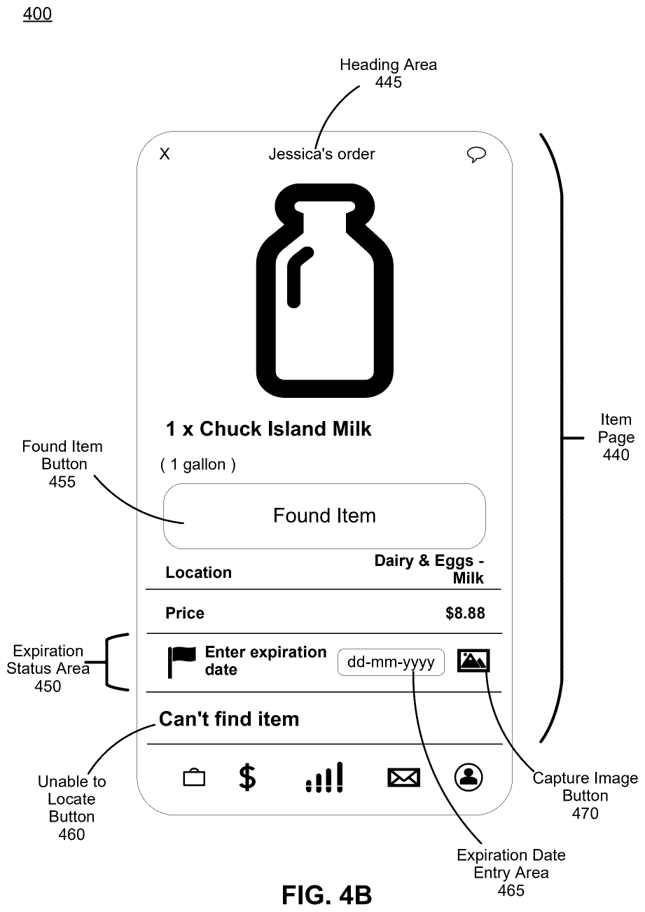

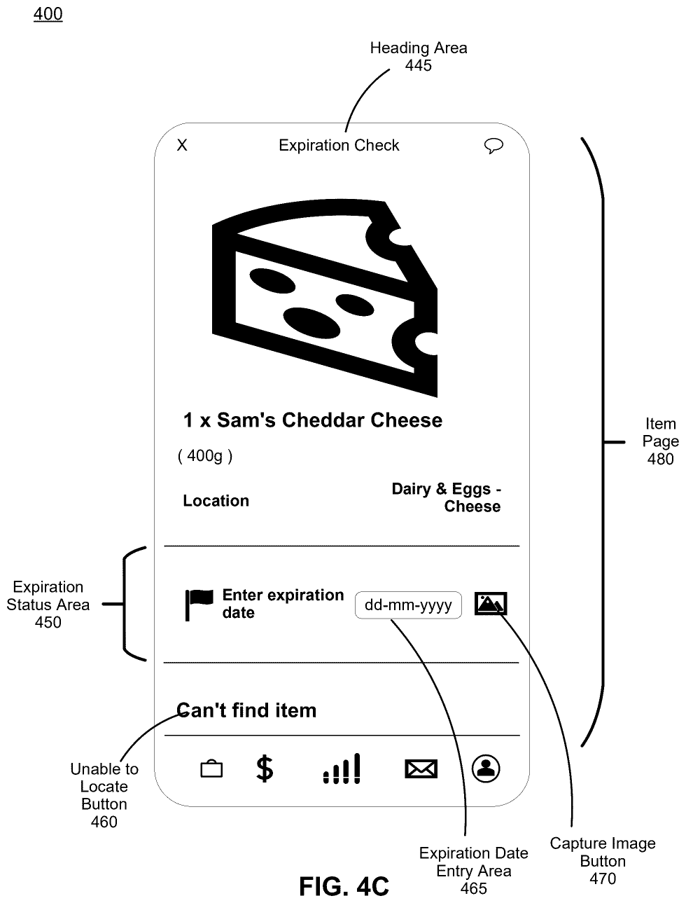

In some embodiments, once a picker associated with the picker client device 110 has determined an expiration status of an item (e.g., perishable item), the picker may update the picker client device 110 (e.g., via the collection interface) with the determined expiration status (e.g., expiration date). The picker client device 110 may be updated with the expiration status via, e.g., a text entry of the expiration date, a text entry of whether an expiration date has passed, an image of the expiration date, an image of the perishable item, or some combination thereof. For example, the picker may use the picker client device 110 to capture an image of the expiration date of the item. In some embodiments, the picker client device may capture a single image of multiple perishable items that are arranged such that expiration dates of the multiple perishable items are all visible to a camera on the picker client device 110. The picker client device 110 may then provide the captured image to the online system 140. Some examples of the collection interface are described in detail below with regard to FIGS. 4A-4C.

In some embodiments, the picker client device 110 may receive instructions from the online system 140 for the picker to remove one or more perishable items that have expired from their display locations within the source location, arrange one or more perishable items by expiration date at their display locations, provide removed items to a store employee, or some combination thereof.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the source location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the source location to the delivery location. Where a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a source location and delivers the order to the delivery location for the order. Alternatively, more than one person may serve the role as a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a customer from a source location.

The source computing system 120 is a computing system operated by a source that interacts with the online system 140. As used herein, a “source” is an entity that operates a “source location,” which is a store, warehouse, consumer package goods (CPG) warehouse, or other building from which a picker can collect items. The source computing system 120 stores and provides item data to the online system 140 and may regularly update the online system 140 with updated item data. For example, the source computing system 120 provides item data indicating which items are available at a source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. In some instances, the source computing system 120 may also track expiration dates for perishable items. The source computing system 120 may update expiration dates of perishable items, based on expiration status information received from the online system 140. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

In some embodiments, the source computing system 120 may generate a source expiration status request for one of its source locations. A source expiration status request is a request to check expiration statuses of one or more perishable items at the source location, perishable items at the source location that fall within one or more item categories (e.g., dairy), or some combination thereof. The source computing system 120 may provide source expiration status requests to the online system 140.

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a source. The online system 140 receives orders from a user client device 100 through the network 130. The online system 140 selects a picker to service the customer's order and transmits the order to a picker client device 110 associated with the picker. The picker collects the ordered items from a source location and delivers the ordered items to the customer. The online system 140 may charge a customer for the order and provide portions of the payment from the customer to the picker and the source.

As an example, the online system 140 may allow a customer to order groceries from a source (e.g., grocery store). The customer's order may specify which groceries they want delivered from the grocery store and the quantities of each of the groceries. The user client device 100 transmits the customer's order to the online system 140 and the online system 140 selects a picker to travel to the grocery store source location to collect the groceries ordered by the customer. Once the picker has collected the groceries ordered by the customer, the picker delivers the groceries to a location transmitted to the picker client device 110 by the online system 140.

The online system 140 performs generation and assignment of expiration status checking tasks for perishable items at one or more source locations. The online system 140 may identify a plurality of candidate perishable items to check for expiration at a source location associated with the source computing system 120.

The online system 140 assigns a picker to check expiration statuses for one or more perishable items at a source location. For example, the online system 140 may apply a plurality of candidate perishable items to an item freshness model to generate scores for the plurality of candidate perishable items. The online system 140 may select, based in part on the scores, one or more of the plurality of candidate perishable items as the one or more perishable items for the picker to check for expiration status. The online system 140 provides instructions to the picker client device 110 to check expiration status for the one or more perishable items. In some embodiments, the picker is assigned to an order from a customer of the online system 140 to be fulfilled at the source location such that the picker can check expiration status for the one or more perishable items while collecting items that are part of the order. And in some embodiments, the order may include one (or more) of the one or more perishable items.

The online system 140 receives expiration status data (e.g., describing whether each of the one or more perishable items has expired) from the picker client device 110. For example, the received expiration status may be text inputs of the expiration date shown on a perishable item, an image of the expiration date on the item, etc. The online system 140 may provide the expiration status data to the source computing system 120 associated with the source location. The online system 140 may charge the source for checking expiration date status and provide portions of the payment from the source to the picker.

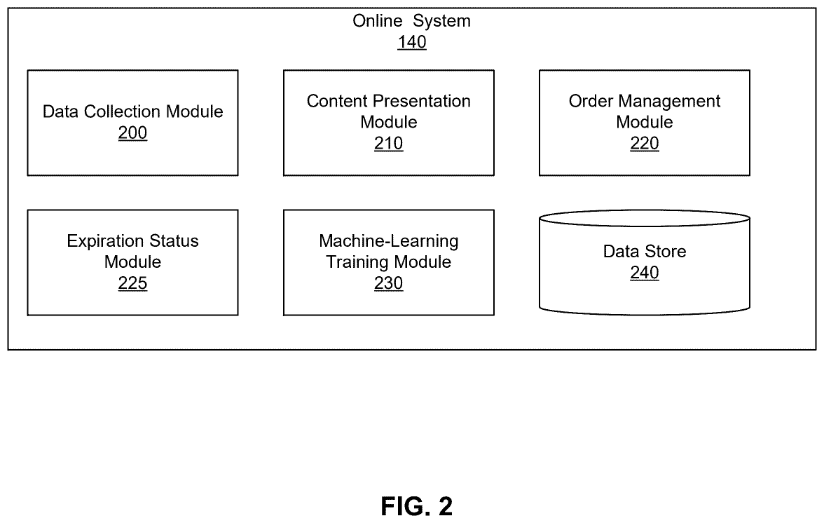

The item freshness model may score perishable items for various source locations associated with the source computing system 120. The online system 140 may select perishable items for expiration status checks to be performed by pickers based in part on the scores. In this manner, the online system 140 can assist the source computing system 120 in keeping shelves stocked at their one or more source locations with non-expired items. Moreover, by maintaining expiration status data (e.g., images of expiration dates) for items provided to customers in orders, the online system 140 can mitigate providing appeasements for erroneous and/or fraudulent claims of receiving expired items. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, an expiration status module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default source/source location, payment instrument, delivery location, or delivery timeframe. The data collection module 200 may collect the customer data from sensors on the user client device 100 or based on the customer's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which sources the picker has collected items at, or the picker's previous shopping history. Additionally, the picker data may include preferences expressed by the picker, such as their preferred sources to collect items at, how far they are willing to travel to deliver items to a customer, how many items they are willing to collect at a time, timeframes within which the picker is willing to service orders, payment information by which the picker is to be paid for servicing orders (e.g., a bank account), whether they have opted in (or out) as being willing to check expiration statuses of perishable items, or some combination thereof. The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a source location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the user client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a source location. For example, the availability model may be trained to predict a likelihood that an item is available at a source location or may predict an estimated number of items that are available at a source location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a user client device 100 and assigns the orders to pickers for service based on picker data. For example, the order management module 220 assigns an order to a picker based on the picker's location and the location of the source location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the customer's order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110 instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the user client device 100 and the picker client device 110. As noted above, a customer may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the source.

The expiration status module 225 performs generation and assignment of expiration status checking tasks for perishable items at one or more source locations. The expiration status module 225 identifies one or more perishable items to check for expiration status at the one or more source locations. In some embodiments, the expiration status module 225 applies a plurality of candidate perishable items to an item freshness model to generate scores for the plurality of candidate perishable items. The plurality of candidate perishable items may be received from, e.g., the source computing system in a source expiration status request.

The item freshness model is a machine learned model that is configured to score each of the plurality of candidate perishable items. To score the plurality of candidate perishable items, the expiration status module 225 may apply model inputs to the item freshness model. The model inputs include some or all of the plurality of candidate perishable items, and may also include, e.g., inventories of items at different source locations, customer complaint data (e.g., prior customer complaints regarding expired perishable items in delivered orders), source expiration status requests (i.e., requests from sources to check expiration statuses of specific perishable items), layouts of source locations, item data and/or order data from smart carts, time since expiration statuses were last checked for items (e.g., by a picker), values of items, item categories (e.g., dairy, baked goods, canned goods, etc.), source locations relative to picker locations, number of items whose expirations statuses are due to be checked, orders for the source locations, lengths of time to taken by pickers to check expiration statuses of perishable items, etc. Note that each source location is associated with its own list of scored candidate perishable items.

The expiration status module 225 selects one or more pickers that are available to check expiration statuses of perishable items. In some embodiments, the expiration status module 225 may select a picker as being available to check expiration statuses of perishable items based in part on their location. For example, if a picker client device 110 is within a threshold distance of a source location, the expiration status module 225 may select a picker associated with the picker client device 110 to check expiration statuses of items at the source location. In some embodiments, the expiration status module 225 may select a picker associated with a picker client device 110 that is entering the source location to fulfill an order for a customer of the online system 140 as being available to check expiration statuses of perishable items at the source location. In another example, the picker may be between orders of the online system 140, but within a threshold distance (e.g., picker client device 110 is within 1 mile or less) from the source location. In some embodiments, a picker is selected prior to scoring the plurality of candidate perishable items. In other embodiments, a picker is selected after the plurality of candidate perishable items is scored.

The expiration status module 225 may select, based in part on the scores, one or more of the plurality of candidate perishable items as one or more perishable items to be assigned to the selected picker for checking expiration statuses at the source location. In some embodiments where the selected picker is also fulfilling an order for a customer, the expiration status module 225 may select a small number (e.g., five items with the highest scores) of the plurality of candidate perishable items as the one or more perishable items to assign the picker to check for expiration status. Or in some cases, the order may include one (or more) of the one or more perishable items that the picker is assigned to check expiration statuses. For embodiments where the selected picker is also fulfilling an order, assigning a small number of perishable items to the picker to check for expiration statuses may help reduce delays in order fulfillment that are due to checking expiration status of perishable items. In contrast, in embodiments where the picker is not assigned an order, but is just assigned to check expiration statuses for the one or more perishable items, the picker may be assigned a relatively large number of perishable items (e.g., 20-30 items) to check expiration dates.

In some embodiments, the expiration status module 225 may select the one or more of the plurality of candidate perishable items as the one or more perishable items for the picker to check for expiration status based in part on locations of the plurality of candidate perishable items relative to locations of items in an order to be fulfilled by a picker. For example, the expiration status module 225 may retrieve location information of items for an order assigned to a picker. The location information may describe locations of items in the source location that are part of the order to be fulfilled by the picker. The expiration status module 225 may adjust the determined scores to account for proximity of candidate perishable items to items in the order. For example, if the order included a first item (e.g., whipping cream), the expiration status module 225 may adjust higher a score for a candidate perishable item (e.g., half and half) which is located close to the first item at the source location, and reduce a score for a second candidate perishable item (e.g., sliced ham) which is located farther from the first item. In other embodiments, the adjustment in scoring is handled by the item freshness model. For example, the item freshness model may account for a candidate perishable item location relative to other items in an order in scoring the candidate perishable item.

The expiration status module 225 provides instructions to the picker client device 110 associated with the selected picker to check expiration statuses for the one or more perishable items. In some embodiments, the expiration status module 225 provides the picker client device 110 with instructions to arrange multiple perishable items such that expiration dates of the multiple perishable items are all visible to a camera on the picker client device 110, and capture an image of the arranged multiple perishable items. In some embodiments, the expiration status module 225 provides the picker client device 110 with instructions for the picker to remove one or more perishable items that have expired from their display locations within the source location, arrange one or more perishable items by expiration date at their display locations (e.g., move items whose expiration dates are close to the front and items whose expiration dates are farther away to the back), provide removed items to a store employee, or some combination thereof.

The expiration status module 225 receives expiration status data from the picker client device 110. Expiration status data describes whether one or more perishable items have expired. For example, the received expiration status data may be text describing the expiration date shown on a perishable item, an image of the expiration date on the perishable item, an image of the perishable item, or some combination thereof. In some embodiments, the expiration status module 225 receives one or more images of items and their expiration dates from the picker client device 110. The expiration status module 225 may, e.g., apply computer-vision techniques to the one or more images to identify the items depicted in the one or more images. The expiration status module 225 may also use, e.g., optical character recognition (OCR) techniques to determine expiration dates in the images for the identified items.

For example, a received image may be of a block of cheese that includes its expiration date, and the expiration status module 225 uses OCR to determine the expiration date for the block of cheese. In one or more other embodiments, the received image may include a plurality of items and their respective expiration dates. The expiration status module 225 may apply computer-vision techniques to identify the perishable items in the image, and use OCR to identify the expiration dates associated with each of the perishable items in the image.

In some embodiments, the expiration status module 225 may also track how long it takes pickers to check expiration statuses of perishable items. The expiration status module 225 may use the monitored times to predict how much time pickers would use to check expiration statuses of perishable items. For example, if pickers are taking longer than some threshold amount of time to check expiration statuses of a number perishable items, the expiration model may reduce the number of perishable items (i.e., select the three highest scored perishable items to check expiration statuses instead of the top five) to check expiration statuses for going forward. Likewise, if pickers are taking less than some threshold amount of time to check expiration statuses of a number perishable items, the expiration model may increase the number of perishable items to check expiration statuses for going forward.

The expiration status module 225 may provide the expiration status data to the source computing system 120 associated with the source location. The expiration status data may be useful to the source computing system 120 in providing an indication of how close perishable items are to expiring at source locations associated with the source computing system 120. Moreover, over time, the expiration data can be used by the source computing system 120 to better manage inventory of perishable items. For example, if a perishable item tends to sit on shelves longer at a first source location relative to a second source location, the source computing system 120 may adjust inventories such that the inventory of the perishable item at the first source location is less than inventory of the perishable item at the second source location.

The expiration status module 225 may update order data for an order that includes perishable items with received expiration status data for those perishable items. For example, if an order included sour cream, and the received expiration status data for the sour cream included a picture of the sour cream and its expiration date, the expiration status module 225 may update the order data to include the received expiration status data. In this manner, the expiration status module 225 generates an accurate record of expiration status for perishable items that are part of orders.

The updated order data may be used by the online system 140 to determine whether an appeasement should be made for a complaint related to a perishable item. For example, the online system 140 may receive from a user client device a complaint for an order due to a perishable item allegedly being expired in the delivered order. The online system 140 may determine an expiration date of the perishable item that was delivered in the order using the updated order data (i.e., the expiration status data for the perishable item). For example, the online system 140 may retrieve an image of the perishable item that shows its expiration date from the updated order data. The online system 140 may determine a response to the complaint based in part on the determined expiration date. For example if the perishable item had expired, the online system 140 may provide an appeasement to the customer. In contrast, if the perishable item was not expired, the online system 140 may provide an explanation to the user client device as to why no appeasement is being made and may include, e.g., the image of the item showing the expiration date. In this manner, by maintaining an accurate record of expiration dates of items provided to customers in orders, the online system 140 can mitigate providing appeasements for erroneous and/or fraudulent claims.

The machine learning training module 230 trains machine learning models used by the online system 140 (e.g., the item freshness model). The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, expiration status data, source expiration request data, customer complaint data, order data, or some combination thereof. In some embodiments, data used for training a machine learning model is prefaced by “training.” For example, a training example may include training expiration status data for a training set of perishable items, training source expiration status requests for the training set of perishable items, and training customer complaint data for the training set of perishable items.

In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

For example, the machine learning training module 230 may be configured to train the item freshness model. The machine learning training module 230 may access a set of training examples. The training examples may include, e.g., training expiration status data for a training set of perishable items, training source expiration status requests for the training set of perishable items, and training customer complaint data for the training set of perishable items, etc. The machine learning training module 230 may apply the item freshness model to the set of training examples to generate a training output corresponding to a predicted set of scores for the training set of perishable items. The machine learning training module 230 may back-propagate one or more error terms obtained from one or more loss functions to update a set of parameters of the item freshness model, and one or more of the error terms are based on a difference between a label applied to a test interaction of the set of training examples and the predicted set of scores. The machine learning training module 230 may stop the back-propagation after the one or more loss functions satisfy one or more criteria.

In some embodiments, the machine learning training module 230 may re-train the item freshness model based in part on real world data. For example, the machine learning training module 230 may determine additional training examples using complaint data, expiration status data for one or more perishable items, order data, lengths of time taken by pickers to check expiration statuses of perishable items, etc. The machine learning training module 230 may retrain the item freshness model based in part on the additional training examples.

The data store 240 stores data used by the online system 140. For example, the data store 240 stores customer data, item data, order data, expiration status data, and picker data for use by the online system 140. The data store 240 also stores trained machine learning models (e.g., item freshness model) trained by the machine learning training module 230. For example, the data store 240 may store the set of parameters for a trained machine learning model on one or more non-transitory, computer-readable media. The data store 240 uses computer-readable media to store data, and may use databases to organize the stored data.

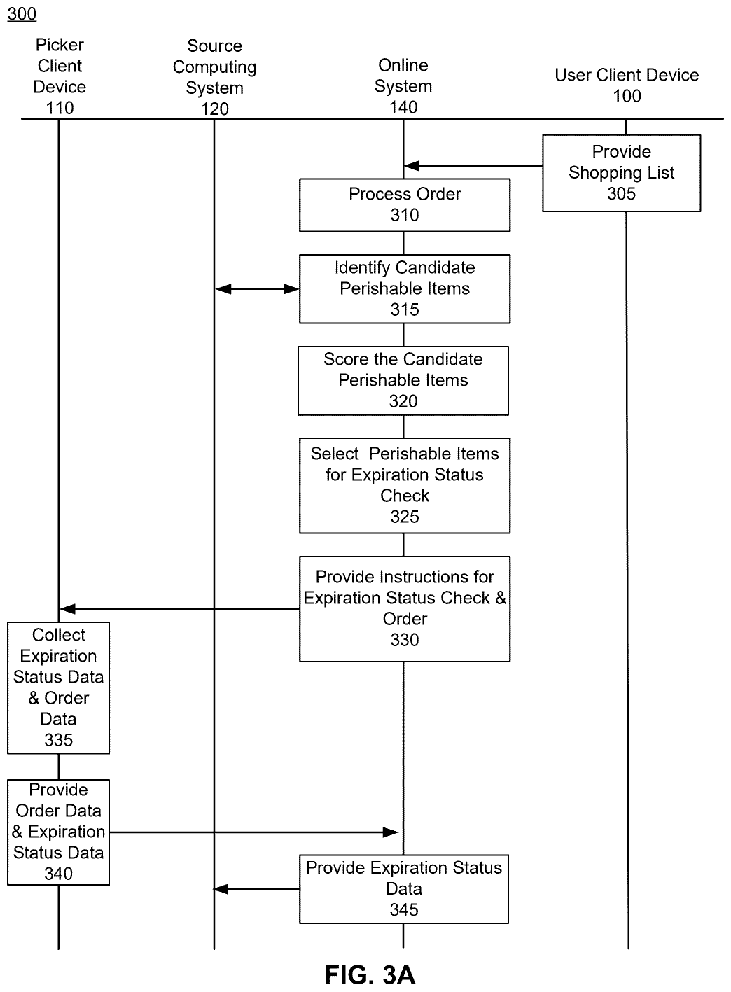

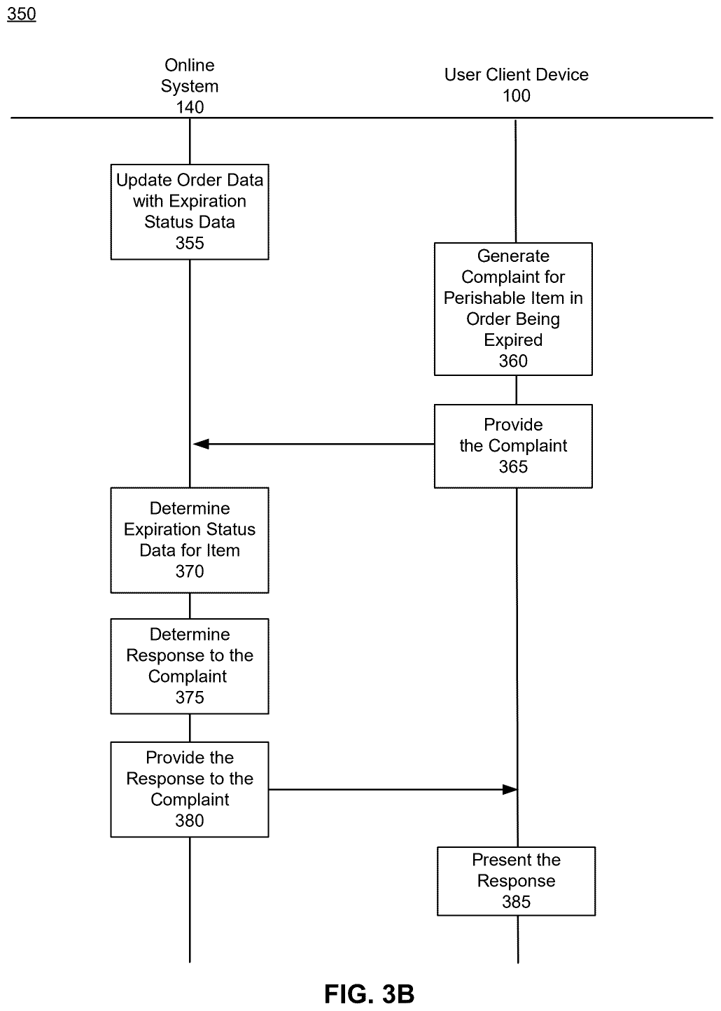

FIG. 3A is an example sequence diagram 300 describing generation and assignment of expiration status checking tasks in conjunction with an order, in accordance with some embodiments. Alternative embodiments may include more, fewer, or different interactions from those illustrated in FIG. 3A, and the steps may be performed in a different order from that illustrated in FIG. 3A. For example, in some embodiments, there is no order that the picker is assigned, and instead the picker is just checking expiration status for one or more perishable items.

A customer associated with the user client device 100 generates a shopping list that is provided 305 to the online system 140. The shopping list includes items to be purchased from a source location as part of an order.

The online system 140 processes 310 the order by selecting a picker associated with the picker client device 110 to shop for the order at the requested source location. The online system 140 may, e.g., select the picker from a pool of pickers based on their location relative to the requested source location, available cargo capacity of their vehicle, picker efficiency score, size and number of requested items, etc. The online system 140 assigns the selected picker to the order to be fulfilled at the source location.

The online system 140 identifies 315 candidate perishable items. The online system 140 may, e.g., communicate with the source computing system 120 associated with the source location to receive a source expiration status request to check expiration statuses of a plurality of perishable items at the source location. In other embodiments, the online system 140 may, e.g., identify candidate perishable items based on item category (e.g., dairy). The online system 140 may identify some or all of the plurality of perishable items in the source expiration status request as candidate perishable items.

The online system 140 scores 320 the candidate perishable items. The online system 140 may, e.g., apply the candidate perishable items to an item freshness model. The item freshness model scores each of the candidate perishable items.

The online system 140 selects 325 one or more perishable items for expiration status checks from the candidate perishable items based on the scores. For example, the online system 140 may rank the scored candidate perishable items from highest to lowest, and select N candidate perishable items with the highest scores (e.g., top 5) as the one or more perishable items for expiration status checks, where N is an integer.

The online system 140 provides 330 instructions to the picker client device 110 associated with the picker to check the one or more perishable items for expiration status and ship for the order. Note in some embodiments (not shown), the online system 140 may provide to the picker client device 110 instructions regarding the order and instructions regarding the expiration status check at different times. For example, the online system 140 may have previously assigned the order to the picker, and once the picker client device 110 is within a threshold distance of the source location (e.g., the picker enters the source location) the online system 140 provides instructions regarding the expiration status check for the one or more perishable items. In some embodiments, the provided instructions may instruct the picker client device 110 to instruct the picker to capture one or more images of expiration dates of the one or more perishable items.

In some embodiments, the provided instructions may also include additional tasks (e.g., requested by the source computing system 120). For example, the provided instructions may instruct the picker to remove one or more perishable items that have expired from their display locations within the source location, arrange one or more perishable items by expiration date at their display locations (e.g., move items whose expiration dates are close to the front and items whose expiration dates are farther away to the back), provide removed items to a store employee, or some combination thereof.

The picker shops for items on the shopping list of the order at the source location. As the picker gathers the one or more items of the order, the picker client device 110 generates order data. The picker also checks expiration statuses of the one or more perishable items. For example, the picker client device 110 may generate expiration status data from image(s) of a perishable item and its expiration date captured using a camera on the picker client device 110, text entered using a collection interface of the picker client device 110 that corresponds to the expiration date for the perishable item, etc. For example, multiple perishable items may be arranged such that expiration dates of the multiple perishable items are all visible to a camera on the picker client device 110, and the picker client device 110 captures an image of the arranged multiple perishable items.

Note in some embodiments, an item that is part of the order is a perishable item, and the picker may update expiration status data for that perishable item. In the above manner, the picker client device 110 collects 335 expiration status data and order data. Once the items on the shopping list have been collected, the picker may deliver them to a delivery location associated with the customer.

The picker client device 110 provides 340 the order data and the expiration status data to the online system 140. In some embodiments, the picker client device 110 provides the expiration status data to the online system 140 separate from the order data. For example, the picker client device 110 may in real time generate and deliver order data to the online system 140 (e.g., as items are collected, when items are delivered to delivery location, etc.). Similarly, the picker client device 100 may in real time generate and deliver expiration status data to the online system 140 (e.g., once expiration status data has been generated for a perishable item).

The online system 140 provides 345 the expiration status data for the one or more perishable items to the source computing system 120. In some embodiments, the online system 140 may periodically provide expiration status data gathered from various pickers over a time period (e.g., daily) for perishable items. In this manner, the online system 140 can assist the source computing system 120 in tracking expired and non-expired items at their one or more source locations. Moreover, the source computing system 120 may use the expiration status data to determine how close items are to expiring, whether they are maintaining too many of a perishable item at a particular source location, etc.

FIG. 3B is an example sequence diagram 350 describing using expiration status data to respond to a complaint stemming from the order of FIG. 3A. Alternative embodiments may include more, fewer, or different interactions from those illustrated in FIG. 3B, and the steps may be performed in a different order from that illustrated in FIG. 3B.

The sequence diagram 350 may begin after step 345 in FIG. 3A. Note that in FIG. 3B, an item in the order processed in FIG. 3A is a perishable item. After receiving the order data and the expiration data from the picker client device 110 at step 340, the online system 140 updates 355 order data for the order that includes the perishable item with received expiration status data for the perishable item. For example, if the order included sour cream, and the received expiration status data for the ricotta cheese included a picture of the ricotta cheese and its expiration date, the online system 140 may update the order data to include the received expiration status data. In this manner, the online system 140 generates an accurate record of expiration status for perishable items that are part of orders.

After the order has been delivered to the delivery location, the customer may use the user client device 100 to generate 360 a complaint for the perishable item in the delivered order as allegedly being expired. For example, the customer may use the ordering interface of the user client device 100 to generate the complaint. The user client device 100 provides 365 the complaint to the online system 140. In one or more embodiments, a user complaint may be logged and used later as a negative training example to train the machine-learning freshness prediction model.

The online system 140 determines 370 an expiration status data for the perishable item. For example, the online system 140 may retrieve expiration status data for the perishable item from the updated order data. The retrieved expiration status data may include, e.g., an image of the perishable item that includes the expiration date that was captured by the picker prior to delivery of the order, a text entry for the expiration date provided by the picker, an image of the item captured by the picker prior to delivery of the order, etc.

The online system 140 determines 375 a response to the complaint. The response is determined based in part on the expiration date indicated in the expiration status data. For example, if the expiration data shows that the item was expired, the online system 140 may provide an appeasement to the customer. In contrast, if the expiration date shows that perishable item was not expired, the online system 140 may generate an explanation as to why no appeasement is being made and may include, e.g., the image of the item showing the expiration date. The online system 140 provides 380 the generated response to the user client device 100. And the user client device 100 presents 385 the response to the customer. In this manner, by maintaining an accurate record of expiration dates of items provided to customers in orders, the online system 140 can mitigate providing appeasements for erroneous and/or fraudulent claims. Note, that the online system 140 may weight an image of the expiration date higher than a text entry of the expiration date in determining whether the perishable item was expired.

FIG. 4A illustrates an example collection interface 400 that is presenting a list of items, in accordance with some embodiments. The collection interface 400 may be the collection interface described above with regard to FIG. 1. The collection interface 400 may be presented on the picker client device 110. The collection interface 400 is a user interface that provides information to a picker on which items to collect for a customer's order and the quantities of the items. The collection interface 400 also presents one or more perishable items for the picker to confirm expiration status. The one or more perishable items may or may not be part of the order. As illustrated, the collection interface 400 includes an item listing area 410. In other embodiments, the collection interface 400 includes different or additional elements. In addition, the functions may be distributed among the elements in a different manner than described.

The item listing area 410 presents items for a picker associated with the picker client device 110 to collect and/or check expiration status. The item listing area 410 may be a scrollable listing of items that are grouped by item category (e.g., dairy & eggs, pantry, etc.). In the illustrated example, items in the “Dairy & Eggs” item category are presented, specifically, item 420a, item 420b, and item 420c. Note that in FIG. 4A, item 420a and item 420b are part of the order for the picker to collect. In contrast, the item 420c is not part of the order and is instead an item that is flagged for an expiration status check. In FIG. 4A, the item 420c is flagged for the expiration status check using an expiration status check badge 430. The expiration status check badge 430 indicates that the item 420c is not part of the order, but is instead an item that the picker is to confirm expiration status. In other embodiments, the distinction between items that are part of the order and items that are for expiration status checks may be emphasized in some other manner. As illustrated, the collection interface 400 groups items with expiration status check badges and items of the order by item category. This may help reduce time spent by the picker in confirming expiration status, as items in a same item category are generally stored close to each other at source locations.

In some embodiments, where the online system 140 has knowledge of item location within a source location, the online system 140 may group the items with expiration status check badges and items of the order by proximity to each other. The online system 140 may then instruct the collection interface 400 to present the items according to the grouping. For example if the item 420c is physically located closer to some other item of the order, the collection interface 400 may present the item 420c adjacent to the other item in the item listing area 410.

As illustrated, the item 420a and the item 420b are part of the order and are perishable items, and the item 420c is also a perishable item. In other embodiments, there may be no items that are part of the order that are perishable items.

As the picker finds items the picker may select the item in the item listing area 410. For example, if the picker is ready to locate (or has located) the item 420a, the picker may select the item 420a in the item listing area 410.

FIG. 4B illustrates the collection interface 400 of FIG. 4A presenting an item page 440 responsive to selection of a perishable item that is part of the order. In FIG. 4B, the collection interface 400 presents the item page 440 responsive to selection of the item 420a in FIG. 4A.

The item page 440 presents information describing a selected item. The item page 440 may include, e.g., a heading area 445, details describing the selected item (e.g., picture of the item, name of the item, price of the item, etc.), an expiration status area 450, a found item button 455, and an unable to locate button 460.

The heading area 445 describes whether the selected item is part of the order or is just for an expiration status check. In the illustrated example, the item 420a is part of the order for the customer (Jessica), as such the heading area 445 reads “Jessica's order.”

The expiration status area 450 includes one or more ways for the picker to provide expiration data to the collection interface 400. In the illustrated example, the one or more means include, e.g., an expiration date entry area 465 and a capture image button 470. The picker may enter an expiration date for a perishable item via the expiration date entry area 465. In some embodiments, the picker may select the capture image button 470 to utilize a camera of the picker client device 110 to capture an image of an expiration date of the perishable item.

The found item button 455 may be selected to indicate that the picker has collected the item 420a. Once selected, the picker client device 110 may update the order to indicate that the picker has collected the item 420a. Likewise, the unable to locate button 460 may be selected to indicate that the picker has been unable to locate the item 420a. Once selected, the picker client device 110 may update the order to indicate that item 420a was not found.

FIG. 4C illustrates the collection interface 400 of FIG. 4A presenting an item page 480 responsive to selection of a perishable item that is not part of the order. In FIG. 4C, the collection interface 400 presents the item page 480 responsive to selection of the item 420c in FIG. 4A.

The item page 480 presents information describing the selected item. The item page 440 may include, e.g., the heading area 445, details describing the selected item (e.g., picture of the item, name of the item, etc.), the expiration status area 450, and the unable to locate button 460.

The heading area 445 describes whether the selected item is part of the order or is just for an expiration status check. In the illustrated example, the item 420c is not part of the order for the customer (Jessica) and instead is just an expiration status check, as such the heading area 445 reads “Expiration Check.”

The expiration status area 450 includes one or means for the picker to provide expiration data to the collection interface 400. In the illustrated example, the one or more means include, e.g., the expiration date entry area 465 and the capture image button 470. The picker may enter an expiration date for an item via the expiration date entry area 465. In some embodiments, the picker may select the capture image button 470 to utilize a camera of the picker client device 110 to capture an image of an expiration date of the item.

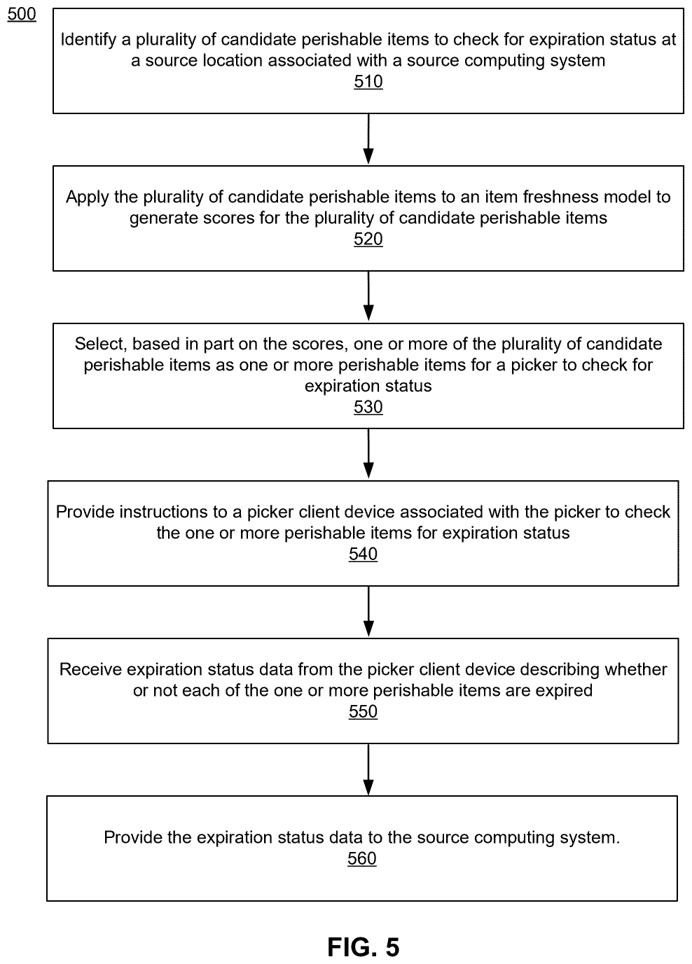

FIG. 5 is a flowchart for a method of generation and assignment of expiration status checking tasks using an item freshness model, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 identifies 510 a plurality of candidate perishable items to check for expiration status at a source location associated with a source computing system (e.g., the source computing system 120). The online system 140 may, e.g., communicate with the source computing system associated with the source location to receive a source expiration status request to check expiration statuses of a plurality of perishable items at the source location. The online system 140 may identify some or all of the plurality of perishable items in the source expiration status request as the plurality of candidate perishable items.

The online system 140 applies 520 the plurality of candidate perishable items to an item freshness model to generate scores for the plurality of candidate perishable items. The item freshness model scores each of the candidate perishable items.

The item freshness model may have been trained by a machine learning training module of the online system. The machine learning training module may have trained the item freshness model by, e.g.: accessing a set of training examples including training expiration status data for a training set of perishable items, training source expiration status requests for the training set of perishable items, and training customer complaint data for the training set of perishable items. The machine learning training module may apply the item freshness model to the set of training examples to generate a training output corresponding to a predicted set of scores for the training set of perishable items. The machine learning training module may back-propagate one or more error terms obtained from one or more loss functions to update a set of parameters of the item freshness model, and one or more of the error terms are based on a difference between a label applied to a test interaction of the set of training examples and the predicted set of scores. The machine learning training module may stop the back-propagation after the one or more loss functions satisfy one or more criteria.

The online system 140 selects 530, based in part on the scores, one or more of the plurality of candidate perishable items as one or more perishable items for a picker to check for expiration status. For example, the online system 140 may rank the scored candidate perishable items from highest to lowest, and select N candidate perishable items with the highest scores (e.g., top 5) as the one or more perishable items for expiration status checks, where N is an integer. The online system 140 may vary a size of N based on, e.g., whether the picker is to perform expiration status checks at the source location, is fulfilling an order at the source location, or both.

The online system provides 540 instructions to a picker client device associated with the picker to check the one or more perishable items for expiration status. In some embodiments, the online system 140 provides the picker client device 110 with instructions for the picker to remove one or more perishable items that have expired from their display locations within the source location, arrange one or more perishable items by expiration date at their display locations (e.g., move items whose expiration dates are close to the front and items whose expiration dates are farther away to the back), provide removed items to a store employee, or some combination thereof.

The online system receives 550 expiration status data from the picker client device describing whether each of the one or more perishable items are expired. For example, the picker client device 110 may generate expiration status data from image(s) of a perishable item and its expiration date captured using a camera on the picker client device 110, text entered using a collection interface of the picker client device 110 that corresponds to the expiration date for the perishable item, etc. The picker client device 110 may provide the generated expiration status data to the online system 140. In some embodiments, the expiration status data may include a single image of a plurality of perishable items that are arranged such that expiration dates of the arranged perishable items are all visible in the image. The online system 140 (and/or the client picker device 110) may use computer vision techniques and/or OCR to identify the perishable items in the image and their corresponding expiration dates.

The online system provides 560 the expiration status data to the source computing system. The source computing system may, e.g., update expiration dates of perishable items, based on expiration status information received from the online system 140. In some embodiments, the source computing system 120 may generate a new source expiration status request for the source location based on the received expiration status data and provide it to the online system 140. In this manner, the online system 140 may assist the source computing system 120 in tracking which items are expired at the source location.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or. ” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
identifying a plurality of candidate perishable items to check for expiration status at a source location associated with a source computing system;
applying the plurality of candidate perishable items to an item freshness model to generate scores for the plurality of candidate perishable items, wherein the item freshness model comprises a machine-learning model trained by:
accessing a set of training examples including training expiration status data for a training set of perishable items, training source expiration status requests for the training set of perishable items, and training customer complaint data for the training set of perishable items,
applying the item freshness model to the set of training examples to generate a training output corresponding to a predicted set of scores for the training set of perishable items,
back-propagating one or more error terms obtained from one or more loss functions to update a set of parameters of the item freshness model, and one or more of the error terms are based on a difference between a label applied to a test interaction of the set of training examples and the predicted set of scores, and
stopping the back-propagation after the one or more loss functions satisfy one or more criteria;
selecting, based in part on the scores, one or more of the plurality of candidate perishable items as one or more perishable items for a picker to check for expiration status;
providing instructions to a picker client device associated with the picker to check the one or more perishable items for expiration status, wherein providing instructions to the picker client device causes the picker client device to display the instructions;
receiving expiration status data from the picker client device describing whether each of the one or more perishable items are expired; and
providing the expiration status data to the source computing system.

2. The method of claim 1, further comprising:
receiving a message indicating a location of the picker client device; and
responsive to the location being within a threshold distance from the source location, instructing the picker associated with the picker client device to check for expiration status of the selected one or more perishable items.

3. The method of claim 1, further comprising:
receiving a message indicating a location of the picker client device; and
responsive to the location being within the source location, instructing the picker to check for expiration status of the selected one or more perishable items.

4. The method of claim 1, further comprising:
providing instructions to the picker client device for the picker to remove any of the selected one or more perishable items that have expired from their display locations at the source location and arrange any remaining of the selected one or more perishable items by expiration date.

5. The method of claim 1, further comprising:
retrieving complaint data associated with a plurality of orders, the complaint data describing complaints for perishable items that had expired and been included in the plurality of orders,
wherein applying the plurality of candidate perishable items to the item freshness model to generate the scores for the plurality of candidate perishable items comprises applying the complaint data to the item freshness model to generate the scores for the plurality of candidate perishable items.

6. The method of claim 1, further comprising:
retrieving locations of items in the source location that are part of an order to be fulfilled by the picker,
wherein selecting the one or more of the plurality of candidate perishable items as the one or more perishable items for the picker to check for expiration status is based in part on locations of the selected one or more perishable items relative to the retrieved locations.

7. The method of claim 1, further comprising:
assigning the picker to an order for a first perishable item to be fulfilled at the source location;
instructing the picker client device to instruct the picker to capture an image of an expiration date of the first perishable item of the one or more perishable items; and
receiving, from the picker client device, expiration status data for the first perishable item that includes the image of the expiration date.

8. The method of claim 7, further comprising:
receiving, from a user client device, a complaint for the order based on the first perishable item allegedly being expired;
identifying an expiration date of the first perishable item that was in the order using the image of the expiration date;
generating a response to the complaint based in part on the identified expiration date; and
providing the response to the user client device.

9. The method of claim 1, further comprising:
assigning the picker to an order that includes multiple perishable items, wherein the order is to be fulfilled at the source location;
instructing the picker client device to instruct the picker to arrange the multiple perishable items such that expiration dates of the multiple perishable items are all visible to a camera on the picker client device;
instructing the picker client device to instruct the picker to capture an image of the arranged multiple perishable items;
identifying the expiration dates for the multiple perishable items from the captured image; and
updating order data for the order with the identified expiration dates.

10. The method of claim 1, further comprising:
generating additional training examples using complaint data and the expiration status data for the one or more perishable items; and
retraining the item freshness model based in part on the additional training examples.

11. A computer program product comprising a non-transitory computer readable storage medium having instructions encoded thereon that, when executed by a processor of a computer system, cause the computer system to perform steps comprising:
identifying a plurality of candidate perishable items to check for expiration status at a source location associated with a source computing system;
applying the plurality of candidate perishable items to an item freshness model to generate scores for the plurality of candidate perishable items, wherein the item freshness model comprises a machine-learning model trained by:
accessing a set of training examples including training expiration status data for a training set of perishable items, training source expiration status requests for the training set of perishable items, and training customer complaint data for the training set of perishable items,
applying the item freshness model to the set of training examples to generate a training output corresponding to a predicted set of scores for the training set of perishable items,
back-propagating one or more error terms obtained from one or more loss functions to update a set of parameters of the item freshness model, and one or more of the error terms are based on a difference between a label applied to a test interaction of the set of training examples and the predicted set of scores, and
stopping the back-propagation after the one or more loss functions satisfy one or more criteria;
selecting, based in part on the scores, one or more of the plurality of candidate perishable items as one or more perishable items for a picker to check for expiration status;
providing instructions to a picker client device associated with the picker to check the one or more perishable items for expiration status, wherein providing instructions to the picker client device causes the picker client device to display the instructions;
receiving expiration status data from the picker client device describing whether each of the one or more perishable items are expired; and
providing the expiration status data to the source computing system.

12. The computer program product of claim 11, further comprising encoded instructions that when executed cause the computer system to perform steps comprising:
receiving a message indicating a location of the picker client device; and
responsive to the location being within the source location, instructing the picker to check for expiration status of the selected one or more perishable items.

13. The computer program product of claim 11, further comprising encoded instructions that when executed cause the computer system to perform steps comprising:
providing instructions to the picker client device for the picker to remove any of the selected one or more perishable items that have expired from their display locations at the source location and arrange any remaining of the selected one or more perishable items by expiration date.

14. The computer program product of claim 11, further comprising encoded instructions that when executed cause the computer system to perform steps comprising:
retrieving complaint data associated with a plurality of orders, the complaint data describing complaints for perishable items that had expired and been included in the plurality of orders;
wherein applying the plurality of candidate perishable items to the item freshness model to generate the scores for the plurality of candidate perishable items comprises applying the complaint data to the item freshness model to generate the scores for the plurality of candidate perishable items.

15. The computer program product of claim 11, further comprising encoded instructions that when executed cause the computer system to perform steps comprising:
retrieving locations of items in the source location that are part of an order to be fulfilled by the picker,
wherein selecting the one or more of the plurality of candidate perishable items as the one or more perishable items for the picker to check for expiration status is based in part on locations of the selected one or more perishable items relative to the retrieved locations.

16. The computer program product of claim 11, further comprising encoded instructions that when executed cause the computer system to perform steps comprising:
assigning the picker to an order for a first perishable item to be fulfilled at the source location;
instructing the picker client device to instruct the picker to capture an image of an expiration date of the first perishable item of the one or more perishable items; and
receiving, from the picker client device, expiration status data for the first perishable item that includes the image of the expiration date.

17. The computer program product of claim 16, further comprising encoded instructions that when executed cause the computer system to perform steps comprising:
receiving, from a user client device, a complaint for the order based on the first perishable item allegedly being expired;
identifying an expiration date of the first perishable item that was in the order using the image of the expiration date;
generating a response to the complaint based in part on the identified expiration date; and
providing the response to the user client device.

18. The computer program product of claim 11, further comprising encoded instructions that when executed cause the computer system to perform steps comprising:
generating additional training examples using complaint data and the expiration status data for the one or more perishable items; and
retraining the item freshness model based in part on the additional training examples.

19. A computer system comprising:
a processor; and
a non-transitory computer readable storage medium having instructions encoded thereon that, when executed by the processor, cause the computer system to perform steps comprising:
identifying a plurality of candidate perishable items to check for expiration status at a source location associated with a source computing system;
applying the plurality of candidate perishable items to an item freshness model to generate scores for the plurality of candidate perishable items, wherein the item freshness model was trained by:
accessing a set of training examples including training expiration status data for a training set of perishable items, training source expiration status requests for the training set of perishable items, and training customer complaint data for the training set of perishable items,
applying the item freshness model to the set of training examples to generate a training output corresponding to a predicted set of scores for the training set of perishable items,
back-propagating one or more error terms obtained from one or more loss functions to update a set of parameters of the item freshness model, and one or more of the error terms are based on a difference between a label applied to a test interaction of the set of training examples and the predicted set of scores, and
stopping the back-propagation after the one or more loss functions satisfy one or more criteria;
selecting, based in part on the scores, one or more of the plurality of candidate perishable items as one or more perishable items for a picker to check for expiration status;
providing instructions to a picker client device associated with the picker to check the one or more perishable items for expiration status, wherein providing instructions to the picker client device causes the picker client device to display the instructions;
receiving expiration status data from the picker client device describing whether each of the one or more perishable items are expired; and
providing the expiration status data to the source computing system.

20. The system of claim 19, further comprising encoded instructions that when executed cause the computer system to perform steps comprising:
assigning the picker to an order for a first perishable item to be fulfilled at the source location;
instructing the picker client device to capture an image of an expiration date of the first perishable item of the one or more perishable items; and
receiving, from the picker client device, expiration status data for the first perishable item that includes the image of the expiration date.
